(19) United States
(12) Patent Application Publication
(10) Pub. No.: US 2009/0279479 A1
(43) Pub. Date: Nov. 12, 2009

(54) Wireless communication system and method of wireless communication

(76) Inventors: Asif Dawoodi Gandhi, Iselin, NJ (US); Devesh T. Patel, Hillsborough, NJ (US); Amit Shah, Wayne, NJ (US); Mathew Thomas, Madison, NJ (US)

Correspondence Address: HARNESS, DICKEY & PIERCE, P.L.C., P.O. BOX 8910, RESTON, VA, 20195, US

(21) Appl. No.: 12/149,722

(22) Filed: May 7, 2008

(51) Int. Cl. H04W 4/00

(52) U.S. Cl. 370/328

(57) ABSTRACT

A wireless communication system is provided that includes a network and a plurality of access terminals. The plurality of access terminals includes a first group of access terminals configured to receive control information at a first data rate and send a response to the received control information, as well as a second group of access terminals configured to receive the control information at a second data rate and send a response to the received control information. The second data rate is higher than the first data rate. The network is configured to send the control information via a control channel at the first data rate and the second data rate, receive responses from the access terminals, and establish a traffic channel with at least one of the access terminals based on the control information and associated response from at least one of the access terminals.

### BACKGROUND

1. Field of the Invention

Example embodiments of the present application relate to a system and method for telecommunications. More particularly, example embodiments are directed to system and methods for more efficiently using the capacity of a control channel.

2. Background Information

Wireless communication systems enable people to communicate with one another over distances without having to necessarily access landline-connected devices such as conventional telephones. Early wireless communication systems were primarily configured for voice communications. However, technological improvements have enabled the development of third generation (3G) and similar wireless networks for both voice and high-speed packet data transfer such as Code Division Multiple Access (CDMA) Evolution Data Optimized or Evolution Data Only (1xEV-DO) systems, for example, are now implemented in many parts of the United States. Elsewhere, CDMA2000.RTM. 3G mobile telecommunications protocol/specification is being used for the high-speed wireless transmission of both voice and non-voice data.

Much of the focus in developing the above mentioned wireless communication networks have focused on improving the use of traffic channels. The use and capacity of control channels and signaling over the control channels used to establish the traffic channels have largely been ignored because the amount of time required for paging an access terminal is generally small compared to the amount of time of an average voice call conducted over a traffic channel. For example, the amount of time for paging an access terminal may be several orders of magnitude less than the time duration of an average voice call. Thus, conventionally, the capacity of the traffic channel has been considered by many as the limiting factor and thus, the control channel capacity has largely been ignored.

### SUMMARY

Example embodiments of the present application are directed towards efficient use of control channels of a wireless communication system.

Example embodiments of the present application are directed towards increasing capacity of the control channel.

An example embodiment relates to a wireless communication system. The wireless communication system includes a network and a plurality of access terminals. The plurality of access terminals includes a first group of access terminals configured to receive control information at a first data rate and send a response to the received control information, as well as a second group of access terminals configured to receive the control information at a second data rate and send a response to the received control information. The second data rate is higher than the first data rate. The network is configured to send the control information via a control channel at the first data rate and the second data rate, receive responses from the plurality of access terminals, and establish a traffic channel with at least one of the plurality of access terminals based on the control information and associated response from at least one of the plurality of access terminals.

An example embodiment provides a wireless communication method. The wireless communication method includes sending control information at a first data rate via a control channel to at least one first access terminal; and sending control information at a second data rate via the control channel to at least one second access terminal. The second data rate is higher than the first data rate.

According to an example embodiment, the method may also include receiving responses from the at least one first access terminal and the at least one second access terminal; and establishing a traffic channel with at least one of the at least one first access terminal and the at least one second access terminal based on the control information and the received responses.

Another example embodiment provides a wireless communication method. The wireless communication method includes sending control information to an access terminal at multiple different data rates over a control channel; receiving a response from the sent control information; and establishing a traffic channel with the access terminal based on the control information and received response. The control information including at least one Medium Access Control (MAC) packet sent at a first data rate and at least one other MAC packet sent at a second data rate. The second data rate is higher than the first data rate.

Still a further example embodiment provides a wireless communication method. The wireless communication method includes receiving control information from a network at multiple different data rates via a control channel; transmitting a response to the network in response to receiving the control information; and establishing a traffic channel with the network based on the received control information. The control information including at least one first Medium Access Control (MAC) packet sent at a first data rate and at least one second MAC packet sent at a second data rate. The second data rate is higher than the first data rate.

Another example embodiment provides a wireless communication method. The wireless communication method includes providing a control channel for communicating data to an access terminal at multiple different data rates. The control includes at least one first Medium Access Control (MAC) packet sent at a first data rate and at least one second MAC packet sent at a second data rate. The second data rate is different than the first data rate.

An example embodiment provides an enhanced control channel. The enhanced control channel includes a plurality of Medium Access Control (MAC) packets, and the plurality of MAC packets includes at least one first MAC packet with control information provided at a first data rate and at least one second MAC packet with control information provided at a second data rate. The second data rate is different than the first data rate.

### BRIEF DESCRIPTION OF THE DRAWINGS

The above and other features and advantages of example embodiments will become more apparent by reviewing the following detailed description of example embodiments of this disclosure with reference to the attached drawings in which:

FIG. 1 illustrates a portion of an example embodiment of a control channel;

FIG. 2 illustrates a wireless communication system according to an example embodiment of the present application;

FIG. 3A illustrates an example embodiment of method performed by a network;

FIG. 3B illustrates an additional step of an example embodiment of a method performed by the network; and

FIG. 4 illustrates an example embodiment of a method performed by an access terminal.

### DETAILED DESCRIPTION OF EXAMPLE EMBODIMENTS

In the following description, for purposes of explanation and not limitation, specific details are set forth such as particular architectures, interfaces, techniques, etc., in order to provide a thorough understanding of example embodiments. However, it will be apparent to those skilled in the art that example embodiments may be practiced in other illustrative embodiments that depart from these specific details. In some instances, detailed descriptions of well-known devices, circuits, and methods are omitted so as not to obscure the description of example embodiments with unnecessary detail. All principles, aspects, and embodiments, as well as specific examples thereof, are intended to encompass both structural and functional equivalents thereof. Additionally, it is intended that such equivalents include both currently known equivalents as well as equivalents developed in the future.

Example embodiments are discussed herein as being implemented in a suitable computing environment. Although not required, example embodiments will be described in the general context of computer-executable instructions, such as program modules or functional processes, being executed by one or more processors or CPUs. Generally, program modules or functional processes include routines, programs, objects, components, data structures, etc. that perform particular tasks or implement particular abstract data types. The program modules and functional processes discussed herein may be implemented using existing hardware in existing communication networks. For example, program modules and functional processes discussed herein may be implemented using existing hardware at existing radio network control nodes.

In the following description, illustrative embodiments will be described with reference to acts and symbolic representations of operations (e.g., in the form of flow charts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, access terminal, base station transceiver station, radio network controller, etc., which reconfigures or otherwise alters the operation of the computer, access terminal, radio network controller and/or base station transceiver station in a manner well understood by those skilled in the art.

Example embodiments are directed at least in part to increasing capacity of a control channel. Stated differently, example embodiments are directed at least in part to efficient use of the capacity of a control channel. Further, example embodiments are directed towards an enhanced control channel for providing control information at multiple data rates.

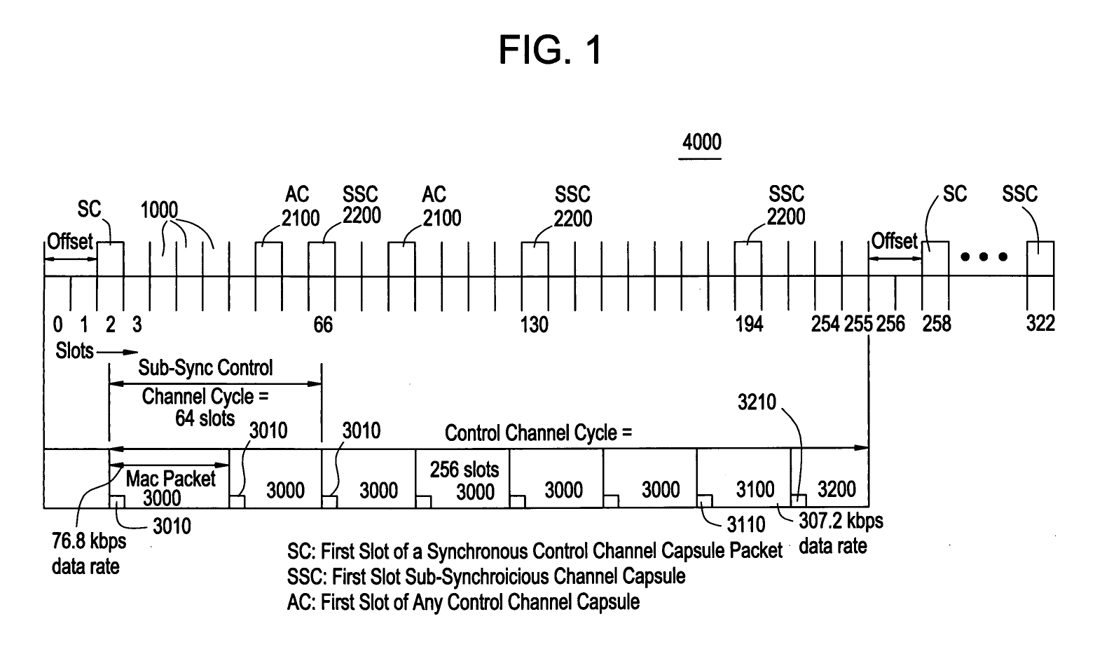

FIG. 1 illustrates an example embodiment of an enhanced control channel and control information sent via the control channel during a time interval.

Referring to FIG. 1, the enhanced control channel 4000 is divided into a plurality of slots 1000. The slots illustrated in FIG. 1 are time slots. One control channel cycle of the example control channel illustrated in FIG. 1 repeats every 256 slots or 426.66 ms. Depending on the control channel payload, the transmission may last for a time duration of up to about 426.66 ms, for example.

FIG. 1 also illustrates that the enhanced control channel 4000 may be used for communicating various different capsules. In particular, FIG. 1 illustrates a first slot of a synchronous control channel capsule (SC) 2000, a first slot of an asynchronous control channel capsule (AC) 2100 and a first slot of a sub-synchronous control channel capsule (SSC) 2200.

As shown in FIG. 1, the SC 2000 may be transmitted every 256 slots, starting with the first slot on “interlace 0”. It is noted that if the first slot of the SC 2000 is slot 2 as shown in the example of FIG. 1, and additional slots are required for the SC 2000, the SC 2000 uses the 6th, 10th, 14th slots etc. A SSC 2200 may be transmitted every 64 slots. The AC 2100 may be transmitted at times in which the SC 2000 and SSC 2200 are not being used for transmitting paging information.

FIG. 1 also illustrates that the enhanced control channel 4000 may be used to communicate up to eight different medium access control (MAC) packets during a control channel cycle. Each of the MAC packets may include signaling information generated by a network for paging one or more access terminals. It is also noted that each of the MAC packets may include headers or trailers. Each MAC packet may include information such as an access terminal identifier used to page a designated access terminal.

Referring to FIG. 1, the first MAC packets 3000 are MAC packets transmitted at a first data rate, and the second MAC packet 3100 is a MAC packet transmitted at a second data rate higher than the first data rate. For example, the first data rate at which the first MAC packets 3000 are transmitted may be 76.8 kbps, whereas the second MAC packet 3100 may be transmitted at the second data rate of 307.2 kbps. Lastly, the third MAC packet 3200 shown in FIG. 1 may be a MAC packet that is reserved for additional information different from the first MAC packets and the second MAC packet, and/or may be a MAC packet transmitted at still another data rate. FIG. 1 also illustrates the first MAC packets 3000 includes headers 3010, the second MAC packet 3100 includes a header 3110, and the third MAC packet includes a header 3210.

Still further, the first MAC packets 3000, the second MAC packet 3100 and the third MAC packet 3200 may be formatted differently. For example, the first MAC packets 3000 may be wrapped with a MAC index that is different from the index of second MAC packet 3100 and the third MAC packet 3200. As such, the wrapping of the MAC packets with a MAC index may be used by the access terminals to derive implicit information about the MAC packets and/or control information being sent in the form of the MAC packets. The implicit information includes rules relating to a protocol of an access terminal such as decoding information, Walsh codes, and a MAC ID of control channels, for example.

One skilled in the art will appreciate that FIG. 1 merely illustrates one example embodiment of the present application and is not intended to be limiting. For example, there may be more or less MAC packets transmitted during each control channel cycle, and the number of first MAC packets communicated at a first data rate and the number of second MAC packets transmitted at the second data rate may vary. As an alternative example embodiment, two of the eight MAC packets may be second MAC packets 3100 transmitted at a higher data rate than the first MAC packets 3000.

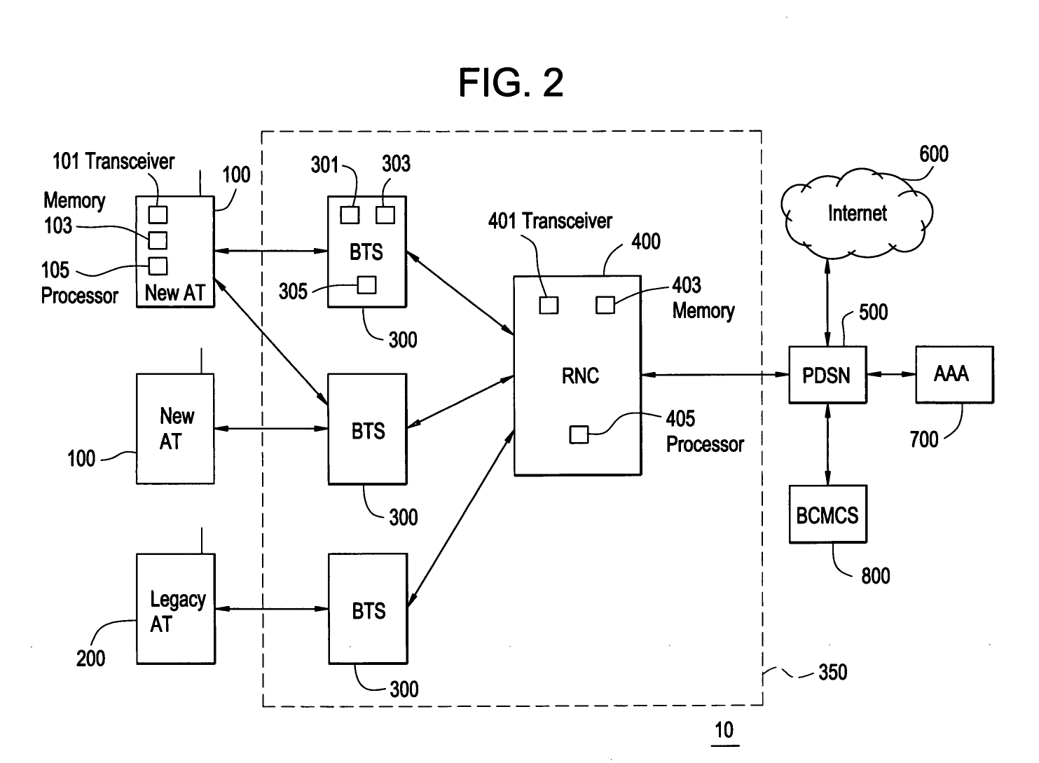

FIG. 2 illustrates a wireless communication system 10 according to an example embodiment of the present application. The wireless communication system 10 implements an enhanced control channel such as the enhanced control channel 4000 described above with respect to FIG. 1. The wireless communication system 10 is a CDMA 1xEV-DO system. However, one skilled in the art will appreciate that the example embodiments described below also apply to various other standards of wireless communication systems and are not intended to be limited to only a CDMA 1xEV-DO system.

Referring to FIG. 2, the wireless communication system 10 includes a plurality of access terminals (AT) 100 and 200, a plurality of base station transceiver station (BTS) 300, a radio network controller (RNC) 400, a packet data serving node (PDSN) 500, the Internet 600, an authentication, authorization and accounting (AAA) component 700, and a broadcast/multicast service content server (BCMCS) 800. Further, FIG. 2 illustrates that the BTS 300 and the RNC 400 are collectively referred to herein as the radio access network (RAN) 350.

The wireless communication system shown in FIG. 2 includes three access terminals 100 and 200. The access terminals 100 and 200 may be mobile phones, personal digital assistants (PDAs), wireless computer routers, etc. FIG. 2 illustrates two different types of access terminals. In particular, FIG. 2 illustrates two enhanced access terminals 100 and a legacy access terminal 200. The legacy access terminal 200 is an access terminal which only receives control information at a single data rate. For example, the legacy access terminal 200 illustrated in FIG. 2 is described below as only receiving control information via a control channel at 76.8 kbits/second (kbps). It is noted that a legacy system such as the CDMA EVDO system provides information via a control channel at 38.4 kbps or 76.8 kbps. However, the rate in a conventional CDMA EVDO system cannot be changed dynamically and thus, is set to either 38.4 or 76.8 kbps.

As described herein, example embodiments of the enhanced access terminals 100 are configured for receiving control information at multiple data rates. For example, an enhanced access terminal 100 may receive control information at both a first data rate of 76.8 kbits/second (kbps) and a second data rate of 307.2 kbps via an enhanced control channel as described with respect to FIG. 1. It is noted that these data rates are not intended to be limiting and that the enhanced access terminals 100 may receive control information at more than two different data rates.

The enhanced access terminals 100 and the legacy access terminal 200 may include a transceiver, memory and processor. For example, the enhanced access terminal 100 shown in FIG. 2 includes a transceiver 101, a memory 103 and a processor 105. The transceiver 101 is configured to receive communications from one or more of the BTSs 300 and transmit information to one or more of the BTSs 300. The memory 103 stores information used and/or required by the enhanced access terminal 100. The processor 105 of the enhanced access terminal 100 controls operations of the enhanced access terminal 100, causes information to be stored in the memory 103, and/or controls reception and transmission of communications performed by the transceiver 101.

The plurality of BTSs 300 provides communications between the RNC 400 and the plurality of access terminals including the enhanced access terminals 100 and the legacy access terminals 200. Each of the BTSs 300 has a service area or cell, and communicates with the access terminals within this service area or cell. As such, when the RNC 400 attempts to establish a traffic channel with one or more of the access terminals, the RNC 400 sends control information including paging information over an enhanced control channel. The control information including paging information may be sent through the plurality of BTSs 300 in order to locate the desired access terminal and determine which of the plurality of BTSs 300 may be used to communicate with the desired access terminal. Each of the BTSs 300 includes a transceiver 301, a memory 303 and a processor 305. The transceiver 301 is configured to receive communications from one or more of the RNC 400 and the access terminals 100 and 200, as well as transmit information to one or more of the RNC 400 and the access terminals 100 and 200. The memory 303 stores information used and/or required by the BTSs 300. For example, the memory 303 may store information about access terminals receiving information or services from the Internet 600, AAA 700 and/or BCMCS 800 via the PDSN 500 and RNC 400. The processor 305 of each BTS 300 controls operations of the BTS 300, causes information to be stored in the memory 303, and/or controls reception and transmission of communications performed by the transceiver 301.

Still referring to FIG. 2, the RNC 400 includes a transceiver 401, a memory 403 and a processor 405. The transceiver 401 is configured to receive communications from one or more of the BTSs 300 and the PDSN 500, as well as transmit information to one or more of the BTSs 300 and the PDSN 500. The memory 403 stores information used and/or required by the RNC 400. For example, the memory 403 may store information about access terminals receiving information or services from the Internet 600, AAA 700 and/or BCMCS 800 via the PDSN 500. The processor 405 of the RNC 400 controls operations of the RNC 400, causes information to be stored in the memory 403, and/or controls reception and transmission of communications performed by the transceiver 401.

According to an example embodiment, the RAN 350 includes information for access terminals identifying the access terminals as enhanced access terminals 100 or legacy access terminals 200. This information may be obtained during configuration negotiations of an access terminal, idle transfer of an access terminal, or during an authentication, authorization or accounting process of an access terminal. Idle transfer refers to when an access terminal moves from a coverage area of one RNC 400 to another RNC 400 without call on and will be understood by one skilled in the art. For example, this information identifying access terminals as enhanced access terminals 100 or legacy access terminals 200 is stored in the memory 403 and/or the memory 303 both of which are shown in FIG. 2 as a component of the RAN 350.

Still referring to FIG. 2, the RNC 400 communicates with the PDSN 500. Further, the PDSN is shown in FIG. 2 as communicating with the Internet 600, the AAA 700 and the BCMCS 800. Accordingly, the PDSN 500 may receive data from the Internet 600 and provide this data to the RNC 400. Similarly, the PDSN 500 may receive services from the BCMCS and provide these services to the enhanced access terminals 100 or the legacy access terminal 200. Further, the PDSN 500 may receive authentication, authorization or accounting information and/or services from the AAA 700.

As previously mentioned, example embodiments are directed towards communicating control information at multiple different data rates via an enhanced control channel. Accordingly, example operations and/or functions performed by various components of the wireless communication system will now be described with reference to FIGS. 1 and 2.

As previously described with respect to FIG. 1, an enhanced control channel may be used to communicate up to eight different medium access control (MAC) packets during a control channel cycle. For example, information received from the PDSN 500 may cause the RAN 350 to page one or more of the access terminals 100 and 200. For example, in response to receiving information from the PDSN 500, the RNC 400 and/or one or more of the BTSs 300 may generate signaling information for paging the one or more access terminals 100 and 200. The signaling information generated by the RNC 400 and/or BTSs 300 is formatted as a MAC packet and transmitted to the one or more access terminals 100 and 200. This formatting includes adding one or more headers or trailers to the packet including signaling information. The MAC packets may then be sequenced and communicated on the enhanced control channel 4000 to an access terminal via one or more of the BTSs 300.

As such, each MAC packet may include information such as an access terminal identifier used to page a designated access terminal. An access terminal may determine if control information communicated via the control channel is designated for the access terminal by reviewing information included in a communicated MAC packet. For example, a legacy access terminal 200 may review the control information included in a MAC packet for an identifier identifying the legacy access terminal 200 as the designated access terminal. The identifier may be included in a MAC packet header 3010, for example. If the legacy access terminal 200 does not find the correct identifier in a received MAC packet, the legacy access terminal 200 ignores the received MAC packet. Alternatively, if the legacy access terminal 200 does find the correct identifier, the legacy access terminal 200 processes the MAC packet and responds accordingly. As another example, an enhanced access terminal 100 may review the control information included in a MAC packet for an identifier identifying the enhanced access terminal 100 as the designated access terminal. If the enhanced access terminal 100 does not find the correct identifier in a received MAC packet, the enhanced access terminal 100 ignores the received MAC packet. Further, if the enhanced access terminal 100 does find the correct identifier, the enhanced access terminal 100 processes the MAC packet and responds accordingly.

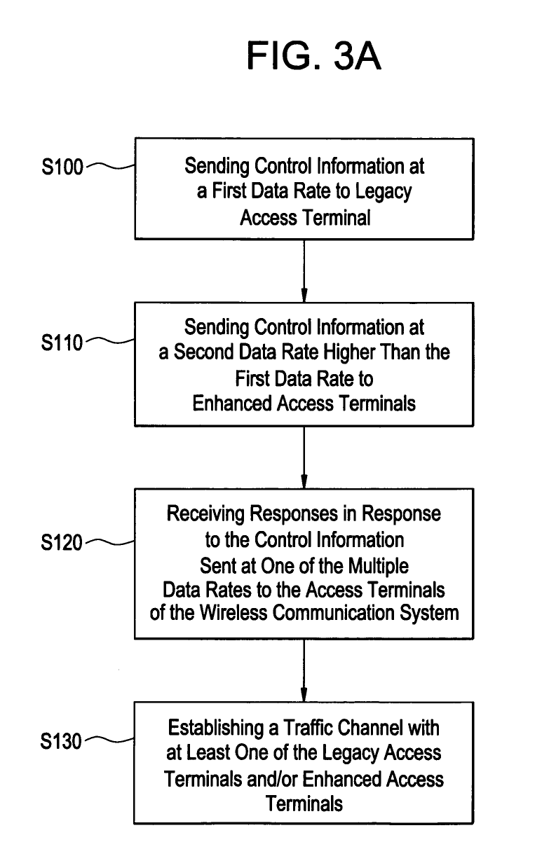

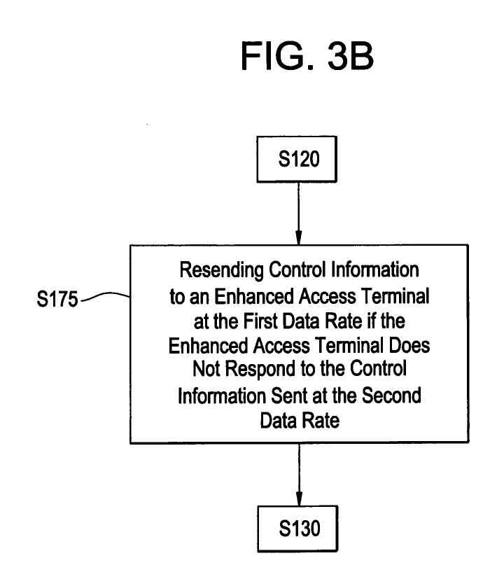

Example embodiments of methods performed by a network are described below with respect to the flowcharts of FIGS. 3A and 3B.

FIG. 3A illustrates an example embodiment of a method performed by a network. In the following description, the steps are described as being performed by the RAN 350 of the wireless communication system 10 illustrated in FIG. 2. As previously mentioned and as indicated in FIG. 2, the RAN 350 includes the BTSs 300 and the RNC 400, as well as the transceivers, memories, and processors included in the BTSs 300 and RNC 400. One skilled in the art will appreciate that one or more of the steps illustrated in FIG. 3A, which may be described as performed by the RNC 400 or components thereof, in one example, may be performed by various other components of the wireless communication system 10 such as the plurality of BTSs or components thereof 300.

Referring to FIG. 3A, the RAN 350 sends control information at a first data rate to a legacy access terminal 200 in step S100. For example, the first data rate may be 76.8 kbps. Further, the control information being sent may include paging information for the legacy access terminal 200. This control information is sent in a MAC packet 3000 and specifically identifies the legacy access terminal 200. For example, the transceiver 401 of the RNC 400 may receive information from the PDSN 500. In response to receiving this information, the processor 405 of the RNC and/or processor 305 of one or more BTSs 300 formats signaling information for paging the legacy access terminal 200 into the MAC packet 3000. In this example, the MAC packet 3000 is formatted to include an identifier specifically identifying the legacy access terminal 200. Further, the MAC packet 3000 designated for the legacy access terminal 200 includes a last packet field, which is included in the header 3010 of the MAC packet 3000.

According to one example of a legacy protocol associated with the legacy access terminal 200, if a bit included in a last packet field is a ‘1’, for example, the legacy access terminal 200 identifies the ‘1’ included in the last packet field of the MAC packet 3000. In response to receiving and identifying the ‘1’ in the last packet field, the legacy access terminal 200 stops monitoring information received on the control channel following reception of the MAC packet 3000 including the ‘1’ in the last packet field until a next scheduled cycle. Alternatively, if the bit in the last packet field of the MAC packet 3000 is a ‘0’, the legacy access terminal 200 will continue monitoring the control channel for following MAC packets in accordance with the protocol associated with the legacy access terminal 200.

In step S110, the RAN 350 sends control information at a second data rate to enhanced access terminals 100. The second data rate is higher than the first data rate. For example, the second data rate may be 307.2 kbps. This control information is sent in a MAC packet 3100 shown in FIG. 1. The transceiver 401 of the RNC 400 may receive a data file from the Internet 600 via the PDSN 500. The data file may be designated for or have been previously requested by an enhanced access terminal 100. In response to receiving the data file at transceiver 401 of the RNC 400, the processor 405 of the RNC and/or the processor 305 of one or more BTSs 300 formats signaling information related to establishing a traffic channel for transmission of the data file into a MAC packet 3100. In this example, the MAC packet 3100 includes an identifier identifying an enhanced access terminal 100 as well as other control information.

In step S120, a transceiver of the RAN 350 such as the transceiver 401 of the RNC 400 receives responses to the control information sent at one or more of the multiple data rates to an access terminal of the wireless communication system shown in FIG. 2. For example, the legacy access terminal 200 responds to the control information sent at the first data rate, and the enhanced access terminals 100 respond to the control information provided at the second, higher data rate. It is noted that enhanced access terminals 100 is configured to respond to control information communicated at multiple data rates. For example, the enhanced access terminals 100 are configured to respond to control information designated to the enhanced access terminal 100 regardless of whether the control information is communicated at 76.8 kbps or 307.2 kbps.

The responses from the various different access terminals may then be processed by the RAN 350 and one or more traffic channels are established with the legacy access terminal 200 and/or the enhanced access terminals 100 based on the control information transmitted to the respective access terminals and responses received from the respective access terminals as illustrated by step S130 of FIG. 3A.

FIG. 3B illustrates another step of an example embodiment performed by a network. In particular, step S125 of FIG. 3B illustrates that if an enhanced access terminal 100 does not respond to control information sent in step S110 shown in FIG. 3A, the RAN 350 resends the control information to the enhanced access terminal 100 at a lower data rate. For example, if the enhanced access terminal 100 cannot receive control information such as paging information sent at 307.2 kbps due to environmental characteristics or the location of the enhanced access terminal 100, the RAN 350 resends the control information at a lower data rate such as 76.8 kbps.

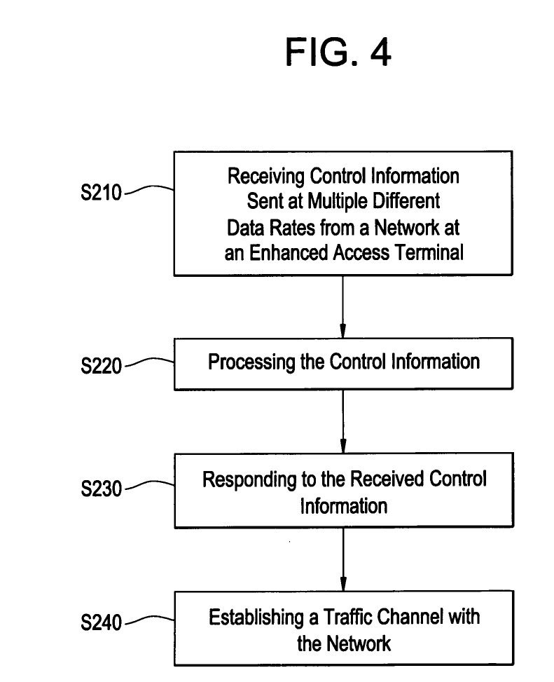

FIG. 4 illustrates an example embodiment of a method performed by an enhanced access terminal 100. Referring to FIG. 4, the enhanced access terminal 100 receives control information from a network via a control channel. As previously discussed, control information designated for the enhanced access terminal 100 includes an identifier associated with the enhanced access terminal as well as other control information used to establish a traffic channel with a network. Further, the control information may be in the form of a MAC packet communication over the control channel shown in FIG. 1. The identifier allows the enhanced access terminal 100 to recognize the control information is targeted for the enhanced access terminal 100. According to an example embodiment, the enhanced access terminal 100 is configured to receive control information via a control channel at multiple different data rates. For example, the enhanced access terminal described below is configured to receive control information via the control channel at a first data rate of 76.8 kbps and a second data rate of 307.2 kbps.

In step S210 of FIG. 4, a transceiver 101 of the enhanced access terminal 100 receives control information, which may then be provided to the processor 105 or stored in the memory 103 of the enhanced access terminal 100.

In response to receiving the control information, the processor 105 of the enhanced access terminal 100 processes the received control information in step S220. In particular, the processor 105 may first review the control information for an identifier associated with the specific enhanced access terminal 100 indicating the received control information is designated for the enhanced access terminal 100. Further, the processor 105 processes the control information to determine if and what form of traffic channel and/or communication is to be expected from the network.

According to an example embodiment, the control information received from the network may be in the form of a MAC packet 3000 or 3100 and may include a plurality of indicators and/or information, which are used by the processor 105 of the access terminal 100 to process the received control information. For example, if a first MAC packet 3000 is transmitted at a first data rate of 76.8 kbps and includes an indicator indicating the MAC packet is the last MAC packet for a legacy access terminal 200, the processor 105 of an enhanced access terminal 100 may interpret this indicator as instructing the enhanced access terminal 100 to continue monitoring the control channel for second MAC packets 3100 transmitted and the second data rate of 307.2 kbps, for example.

It is noted that, according to an example embodiment, the bit included in the last packet field may be interpreted differently by enhanced access terminal 100 than the same indicator would be interpreted by a legacy access terminal 200. For example, in response to receiving a MAC packet 3100 at the second data rate, which includes a ‘1’, the processor 105 of the enhanced access terminal will continue monitoring the control channel, whereas the legacy access terminal 200 would discontinue monitoring the control channel. Further, because the MAC packet 3100 is transmitted at a higher data rate, additional control information may continue to be provided to the enhanced access terminal 100 and the communication of this additional control information will require less control channel resources since the MAC packet 3100 is transmitted at a higher data rate and uses a format that reduces the number of slots needed for its transmission.

Referring to step S230 of FIG. 4, the enhanced access terminal 100 responds to the received control information. For example, if the processor 105 determines the received control information is designated for the enhanced access terminal 100 and determines a traffic channel should be established with the RNC 400, the processor 105 generates an appropriate response and instructs the transceiver 101 of the enhanced access terminal 100 to respond to the received control information.

In step S240 of FIG. 4, a traffic channel is established between the enhanced access terminal and the network.

As previously mentioned, example embodiments are directed towards increasing capacity of the control channel and/or efficient use of the capacity of a control channel. As wireless communication systems continue to evolve, the use of the control channel capacity is becoming increasingly important. Whereas a typical voice call may last hundreds of seconds, a push-to-talk communication or transfer of a data file from the Internet may only require seconds of communications via a traffic channel. For example, if the communication only requires 20 seconds of a traffic channel, the paging time duration to data transfer time duration ratio is 1 to 200. Accordingly, the paging channel could become a limiting factor.

The specific example described below further illustrates features of the various example embodiments described above. In this example, the first data rate is 76.8 kbps and 25% of the capacity of the control channel is occupied for paging legacy access terminals 200. If the second data rate is 307.2 kbps, enhanced access terminals 100 are paged approximately four times faster than legacy access terminals 200 since 307.2 kbps is approximately four times faster than 76.8 kbps. Stated differently, paging the enhanced access terminals at 307.2 kbps requires about four times fewer of the number of available slots in the control channel. Assuming 90% of the access terminals are enhanced access terminals 100 being served are provided control information at the second data rate of 307.2 kbps, the slot occupancy for these enhanced access terminals 100 for 90% of the users can be roughly calculated as (25/4) plus 0.1×25=8.75% or about 9% of the slots in one control channel cycle.

Example embodiments being thus described, it will be obvious that the same may be varied in many ways. Such variations are not to be regarded as a departure from the example embodiments, and all such modifications are intended to be included within the scope.

We claim:

1. A wireless communication system comprising:
a plurality of access terminals including
a first group of access terminals configured to receive control information at a first data rate and send a response to the received control information, and
a second group of access terminals configured to receive the control information at a second data rate and send a response to the received control information, the second data rate being higher than the first data rate; and
a network configured to send the control information via a control channel at the first data rate and the second data rate, receive responses from the plurality of access terminals, and establish a traffic channel with at least one of the plurality of access terminals based on the control information and associated response from at least one of the plurality of access terminals.

2. The wireless communication system of claim 1, wherein the second group of access terminals are configured to also receive the control information as the first data rate.

3. The wireless communication system of claim 1, wherein the first data rate is 76.8 kbps and the second data rate is 307.2 kbps.

4. The wireless communication system of claim 1, wherein the network is further configured to resend the control information to at least one access terminal of the second group of access terminals at the first data rate if the at least one access terminal is not responding to the control information sent at the second data rate.

5. The wireless communication system of claim 1, wherein
the control information includes at least one first Medium Access Control (MAC) packet and at least one second MAC packet,
the control channel includes a plurality slots, and
the network is further configured to allocate a first number of the plurality of slots for sending the at least one first MAC packet at the first data rate and a second number of the plurality of slots for sending the at least one second MAC packet at the second data rate.

6. The wireless communication system of claim 5, wherein
each MAC packet includes an indicator associated with an access terminal and each access terminal is configured to compare the indicator of a received MAC packet with the indicator associated with the access terminal to determine if the received MAC packet is to be processed by the access terminal.

7. The wireless communication system of claim 6, wherein each MAC packet further includes a last packet field, and
the network is further configured to include set an indicator in the last packet field instructing the first group of access terminals to process the control information and stop monitoring the control channel until a next scheduled cycle and instructing the second group of access terminals to continue monitoring the control channel for control information being sent at the second data rate.

8. The wireless communication system of claim 5, wherein at least one first Medium Access Control (MAC) packet including signaling information and at least one second MAC packet including signaling information are wrapped with different MAC indexes,
the first group of access terminal are configured to process MAC packets wrapped with the first MAC index, and
the second group of access terminals are configured to process MAC packets wrapped with the first MAC index and a second MAC index.

9. A wireless communication method, the method comprising:
sending control information at a first data rate via a control channel to at least one first access terminal;
sending control information at a second data rate via the control channel to at least one second access terminal, the second data rate being higher than the first data rate;
receiving responses from the at least one first access terminal and the at least one second access terminal; and
establishing a traffic channel with at least one of the at least one first access terminal and the at least one second access terminal based on the control information and the received responses.

10. The method of claim 9, further comprising:
resending the control information to the at least one second access terminal at the first data rate if the at least one second access terminal does not respond to the control information sent at the second data rate.

11. The method of claim 9, wherein the sent control information includes at least one first Medium Access Control (MAC) packet sent at the first data rate and at least one second MAC packet sent at the second data rate.

12. The method of claim 11, wherein each MAC packet includes an indicator, the indicator identifies the access terminal the MAC packet is directed to.

13. The method of claim 12, wherein each MAC packet further includes a last packet field having a bit instructing the at least one first access terminal to process the control information and stop monitoring the control channel until a next scheduled cycle and instructing the at least one second access terminal to continue monitoring the control channel for control information sent at the second data rate.

14. The method of claim 9, wherein the first data rate is 76.8 kbps and the second data rate is 307.2 kbps.

15. A wireless communication method, the method comprising:
sending control information to an access terminal at multiple different data rates over a control channel, the control information including at least one first Medium Access Control (MAC) packet sent at a first data rate and at least one second MAC packet sent at a second data rate, the second data rate being higher than the first data rate;
receiving a response from the sent control information; and
establishing a traffic channel with the access terminal based on the control information and received responses.

16. The method of claim 15, further comprising:
resending the control information at a lower data rate if the access terminal does not respond to the sent control information.

17. The method of claim 15, further comprising:
allocating a first number of slots of the control channel for sending the at least one first Medium Access Control (MAC) packet at the first data rate and a second number of slots of the control channel for sending the at least one second MAC packet at the second data rate.

18. The method of claim 15, further comprising:
storing information regarding the access terminal; and
sending the control information to the access terminal at multiple data rates based on an indicator in the stored information indicating the access terminal is configured to receive control information at the multiple different data rates.

19. The method of claim 15, wherein the first data rate is 76.8 kbps and the second data rate is 307.2 kbps.

20. A wireless communication method, the method comprising:
receiving control information from a network at multiple different data rates via a control channel, the control information including at least one first Medium Access Control (MAC) packet sent at a first data rate and at least one second MAC packet sent at a second data rate, the second data rate being higher than the first data rate;
transmitting a response to the network in response to the received control information; and
establishing a traffic channel with the network based on the received control information.

21. A wireless communication method, the method comprising:
providing a control channel for communicating data to an access terminal at multiple different data rates, the control includes at least one first Medium Access Control (MAC) packet sent at a first data rate and at least one second MAC packet sent at a second data rate, the second data rate being different than the first data rate.

22. An enhanced control channel comprising:
a plurality of MAC packets including at least one first Medium Access Control (MAC) packet with control information provided at a first data rate and at least one second MAC packet including control information provided at a second data rate, the second data rate being different than the first data rate.
